(19) United States
(12) Patent Application Publication
(10) Pub. No.: US 2025/0147787 A1
(43) Pub. Date: May 8, 2025

(54) CLOUD INTEGRATED MANAGEMENT SYSTEM AND CLOUD INTEGRATED MANAGEMENT METHOD BASED ON KUBERNETES ENVIRONMENT

(71) Applicant: OKESTRO CO., LTD., Seoul (KR)

(72) Inventors: Chang Woo SONG, Seoul (KR); Myeong Kil KIM, Seoul (KR); Keun Su LEE, Seoul (KR); Min Jeong CHOI, Seoul (KR); Young Gwang KIM, Seoul (KR); Min Jun KIM, Seoul (KR)

(73) Assignee: OKESTRO CO., LTD., Seoul (KR)

(21) Appl. No.: 18/512,988

(22) Filed: Nov. 17, 2023

(30) Foreign Application Priority Data
Nov. 8, 2023 (KR) 10-2023-0153790

(51) Int. Cl. G06F 9/455

(52) U.S. Cl. CPC G06F 9/45558; G06F 2009/45595

(57) ABSTRACT

A cloud integrated management system for providing integrated cloud services based on a container and a virtual machine according to an embodiment of the present disclosure may include: a worker module that operates at least one pod including at least one container; and a master module that receives a command of a manager and transmits the command of the manager to the worker module, wherein the master module may transmit the received command of the manager to the worker module and the virtual machine.

### CROSS-REFERENCE TO RELATED APPLICATION(S)

This application is based on and claims priority under 35 U.S.C. § 119 to Korean Patent Application No. KR10-2023-0153790, filed on Nov. 8, 2023, in the Korean Intellectual Property Office, the entire disclosure of which is herein incorporated by reference in its entirety.

### TECHNICAL FIELD

The present disclosure relates to a cloud integrated management system and cloud integrated management method for system operation in a Kubernetes environment.

### BACKGROUND

Cloud technology is being adopted and applied in many industrial fields along with the rapid development of Internet and computing technology. Cloud services are divided into IAAS, PAAS, and SASS. The IASS refers to a service that lends virtual infrastructure such as servers, networks, storage, memory, and CPU. The PAAS includes application design, development, testing, distribution, and hosting, and lends all resources necessary to provide applications and services. In other words, the PAAS is a service that provides a platform including development and operating environment. The SASS is software provided through the cloud and refers to receiving applications and services installed in the public cloud over the Internet without a separate installation or switching process. Herein, container-based cloud services, which feature lightweight and easy-to-configure microservices, have recently been in the spotlight, and as a result, the utilization of a Kubernetes platform, which may manage and operate containers, is increasing.

However, services that have high CPU usage, use GPU, or are not stateless require configuring a separate virtual machine, so it is necessary to create a cloud service by creating an application by creating a container and a virtual machine together. This causes the inconvenience of managers having to manage virtual machines and containers separately.

### SUMMARY

The present disclosure is directed to addressing an issue associated with the related art, and to providing a cloud integrated management system and cloud integrated management method capable of managing virtual machines and containers together in a Kubernetes environment.

The cloud integrated management system for providing integrated cloud services based on a container and a virtual machine according to an embodiment of the present disclosure may include: a worker module that operates at least one pod including at least one container; and a master module that receives a command of a manager and transmits the command of the manager to the worker module, wherein the master module may transmit the received command of the manager to the worker module and the virtual machine.

In addition, the worker module may include a worker pod that performs information processing for a cloud service provided to a client and an intermediate pod that transmits the command of the manager transmitted by the master module to the virtual machine.

In addition, the intermediate pod may be directly communicatively connected to the virtual machine through tunneling.

In addition, there is further included an interface module that calculates a main interface, which is a user interface into which the command of the manager transmitted by the master module is able to be input, wherein the interface module may calculate a first main interface into which the command of the manager for controlling the worker pod is able to be input and a second main interface into which the command of the manager for controlling the virtual machine is able to be input through the intermediate pod.

In addition, the master module may create the intermediate pod only when a predetermined activation condition is satisfied so that the command of the manager is able to be transmitted to the virtual machine through the worker module.

In addition, there is further included: an interface module that calculates a main interface, which is a user interface into which the command of the manager transmitted by the master module is able to be input, and an auxiliary interface, which is different from the main interface and is a user interface into which the command of the manager for the virtual machine is able to be input; and a determination module that determines whether the predetermined activation condition is satisfied, wherein the predetermined activation condition may be a condition in which an integrated inconvenience index, which is an index of inconvenience of the manager caused while using both the main interface and the auxiliary interface, is greater than or equal to a predetermined reference.

In addition, the determination module may calculate the integrated inconvenience index by averaging a first inconvenience index calculated by comparing a manager manipulation of the main interface and a manager manipulation of the auxiliary interface and a second inconvenience index calculated through switching times of the main interface and the auxiliary interface.

In addition, the determination module may calculate the integrated inconvenience index by further considering a third inconvenience index, which is information related to a mood of the manager, during a switching process between the main interface and the auxiliary interface.

In addition, the determination module may change weights at which the first inconvenience index, the second inconvenience index, and the third inconvenience index are reflected in the integrated inconvenience index according to objective information of the manager.

The cloud integrated management method according to an embodiment of the present disclosure may be implemented by a cloud integrated management system and be configured to provide cloud services based on a container and a virtual machine, wherein the method may include: operating, by a worker module, at least one pod including at least one container; receiving, by a master module, a command of a manager; and transmitting, by the master module, the command of the manager to the worker module and the virtual machine.

The cloud integrated management system and cloud integrated management method according to an embodiment of the present disclosure can maximize management convenience.

In addition, the efficiency of cloud resource use can be maximized.

In addition, the work convenience of a manager can be maximized.

However, the benefits of the present disclosure are not limited to those mentioned above, and other benefits not mentioned herein will be clearly understood by those skilled in the art from the following description and the attached drawings.

### BRIEF DESCRIPTION OF THE DRAWINGS

FIG. 1 is a conceptual diagram of a cloud integrated management system according to an embodiment of the present disclosure.

FIG. 2 is a block diagram of the cloud integrated management system according to an embodiment of the present disclosure.

FIG. 3 is a flowchart of a cloud integrated management method according to an embodiment of the present disclosure.

FIG. 4 is an operation diagram of the cloud integrated management system according to an embodiment of the present disclosure.

FIG. 5 is an example of a main interface calculated by an interface module of the cloud integrated management system according to an embodiment of the present disclosure.

FIG. 6 is a diagram for explaining a third inconvenience index calculated by a determination module of the cloud integrated management system according to an embodiment of the present disclosure.

### DETAILED DESCRIPTION

Hereinafter, specific embodiments of the present disclosure will be described in detail with reference to the drawings. However, the spirit of the present disclosure is not limited to the presented embodiments, and those skilled in the art who understand the spirit of the present disclosure will be able to easily suggest other regressive inventions or other embodiments included within the scope of the present disclosure by adding, changing, or deleting other components within the scope of the same spirit, but this will also be said to be included within the scope of the spirit of the present disclosure.

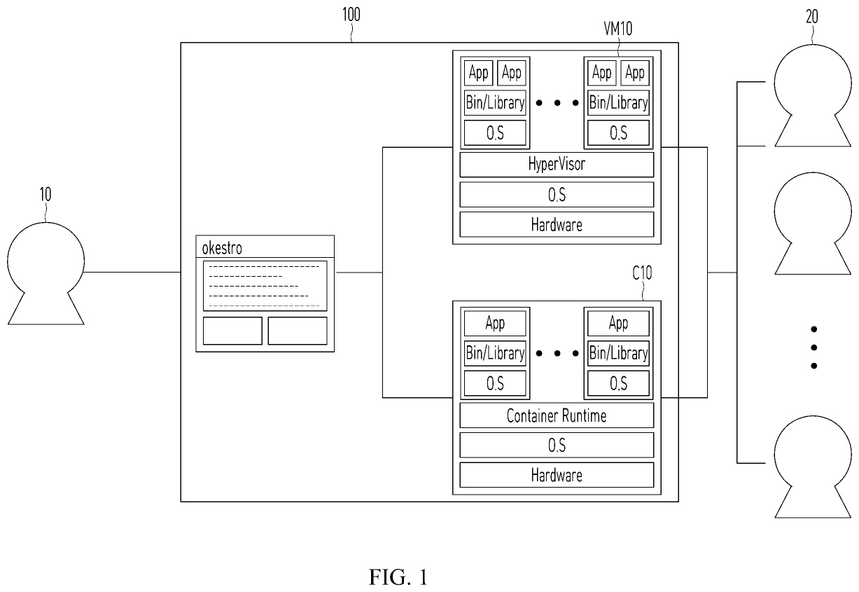

FIG. 1 is a conceptual diagram of a cloud integrated management system according to an embodiment of the present disclosure.

Referring to FIG. 1, a manager 10, a cloud integrated management system 100, and a client 20 may be connected to a network to enable wired/wireless information communication.

The wireless network mentioned in an embodiment of the present disclosure may be a core network integrated with a wired public network, a wireless mobile communication network, or a mobile Internet, and may refer to a worldwide open computer network structure that provides TCP/IP protocols and various services existing at the upper layer thereof, such as HTTP (Hyper Text Transfer Protocol), HTTPS (Hyper Text Transfer Protocol Secure), Telnet, FTP (File Transfer Protocol), DNS (Domain Name System), and SMTP (Simple Mail Transfer Protocol). The wireless network is not limited to examples, but comprehensively refers to a data communication network that may transmit and receive data in various forms.

The manager 10 may refer to a person who operates and controls the cloud integrated management system 100.

The manager 10 may create, operate and delete a virtual machine using the cloud integrated management system 100, may create applications using the virtual machine, and may provide cloud services using the virtual machine.

In addition, the manager may create, operate, and delete pods including a container using the cloud integrated management system 100, create applications using pods, and provide cloud services using the container.

Hereinafter, the manager may also include the computing device used by the manager.

There may be one or a plurality of managers.

For example, computing devices may include mobile terminals including desktop computers, laptops, smartphones, PDAs (Personal Digital Assistants), PMPs (Portable Multimedia Players), portable terminals, and/or smart TVs.

Hereinafter, the meaning of a user may include the computing device of the user.

The client 20 may refer to a device that is connected to a network to a node configured of a pod and a virtual machine and uses resources, applications, and infrastructure provided by a cloud.

The client 20 is a device used by a user who receives a cloud service, and hereinafter, the client 20 may be used as a term to mean the user itself.

A client may be a computing device or a kind of server.

The cloud integrated management system 100 is a facility composed of computing devices and/or servers, and may refer to a combination of all devices required to implement a cloud integrated management method.

The server mentioned in an embodiment of the present disclosure may include other components for performing a server environment. The server may include all arbitrary types of devices.

For example, the server as a digital device may be a digital device with a calculation capability, which has a processor installed therein and a memory, such as a laptop computer, a notebook computer, a desktop computer, a web pad, or a mobile phone.

In one example, the server may be a web server. However, it is not limited thereto, and the type of server may be changed in various ways at a level that is obvious to those skilled in the art.

The cloud integrated management system may virtualize the pods configuring a container and a virtual machine.

A virtual machine VM10 may be a complete machine that is virtualized in hardware and executes all components, including its own operating system. The virtual machine may have the benefit of being able to use computing resources more efficiently than the physical machine itself.

A container C10 does not have their own operating system and communicate with the hardware operating system through a container engine or container runtime, and thus is lighter than the virtual machine and may have the benefit of being easier to deploy and manage.

The cloud integrated management system may form and manage the container and the virtual machine according to the purposes and ways.

Hereinafter, the cloud integrated management system 100 will be described in detail.

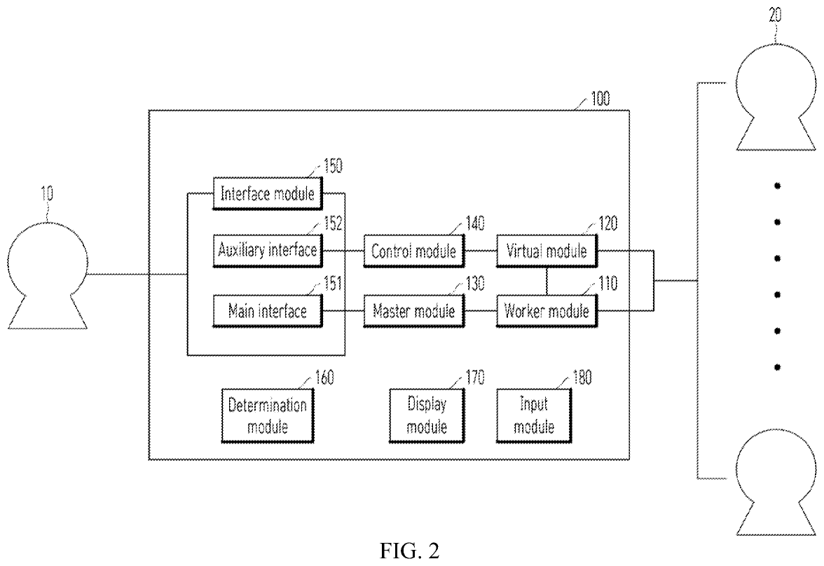

FIG. 2 is a block diagram of the cloud integrated management system according to an embodiment of the present disclosure.

Referring to FIG. 2, the cloud integrated management system 100 for providing integrated cloud services based on a container and a virtual machine according to an embodiment of the present disclosure may include: a worker module 110 that operates at least one pod including at least one container; a virtual module 120 that operates at least one virtual machine; and a master module 130 that transmits a command of a manager to the worker module 110.

In addition, the cloud integrated management system 100 may further include: a control module 140 that directly transmits a command of a manager to the virtual module 120; an interface module 150 that calculates a main interface 151, which is a manager interface into which the command of the manager transmitted by the master module 130 is able to be input, and an auxiliary interface 152, which is different from the main interface 151 and is a manager interface into which the command of the manager for the virtual machine is able to be input; and a determination module 160 that determines whether a predetermined activation condition is satisfied

In addition, the cloud integrated management system 100 may further include a display module 170 that displays a user interface and an input module 180 that is manipulated by a manager to input a command signal.

Each module may be connected wired/wireless to enable information communication with each other or one another.

The worker module 110 (Kubernetes Node) may virtualize and operate pods configurating at least one container.

In addition, the worker module 110 may be configured as one node by bundling at least one pod.

A node may be a component that receives commands from the master module 130, creates an actual workload, and performs a cloud service.

The number of pods within the node may be increased or decreased, providing flexible cloud services according to the commands of the master module 130.

As an example, the node may include a kulet, Kube-proxy, cAdvisor, and container runtime. The detailed description thereof may be omitted within the scope of known technology.

At least one node may be formed in the worker module 110.

For example, the worker module 110 may have a plurality of nodes and a single node may have a plurality of pods.

Hereinafter, detailed descriptions of nodes, pods, and containers may be omitted within the scope of known technology.

The worker module 110 may be provided with a worker pod that performs information processing for cloud services provided to clients and an intermediate pod that transmits the command of the manager transmitted by the master module 130 to the virtual machine of the virtual module 120.

Pods driven in the worker module 110 may be divided into worker pods and intermediate pods.

For example, the worker pod may provide a cloud service to a client by opening a service port to the client and transmitting information to the client through Kube-proxy.

For example, the intermediate pod may perform the function of intermediary so that the master module 130 and the virtual module 120 may communicate, and open the service port only to the virtual machine corresponding to the intermediate pod within the virtual module 120, allowing a manager to control the virtual machine through the master module 130.

The intermediate pod may be directly communicatively connected to the virtual machine of the virtual module 120 through tunneling.

Specifically, the intermediate pod may be connected to the virtual machine corresponding to the intermediate pod through tunneling to enable direct information communication.

The intermediate pod may be connected to the virtual machine of the virtual module 120 to enable information communication through tunneling, or may be connected to the virtual machine of the virtual module 120 to enable information communication through the control module 140.

The master module 130 may transmit the command of the manager to the worker module 110 so that the worker module 110 is driven according to the command of the manager.

The master module 130 may control the entire Kubernetes cluster.

The master module 130 may allocate resources to appropriate nodes and perform control to increase or decrease the number of pods required for a node.

Specifically, the master module 130 (Kubernetes Master) may include an API server (apisever), scheduler, controller manager, etcd, and DNS.

The API server may communicate with other components of the manager, worker module 110, and master module 130. The API server may also process requests for the internal configuration of the master module 130, check authority, and reject external requests.

Etcd may act as a database for a Kubernetes cluster, and etcd may interact with the API server.

Herein, the Kubernetes cluster may be a term for a concept that includes the master module 130 and the worker module 110.

A scheduler may play the role of allocating resources required for cloud services to appropriate nodes.

The control manager may create controllers (Replica Controller, Service Controller, Volume Controller, Node Controller, etc.) and distribute the same to each node to manage the same.

Hereinafter, the detailed descriptions of each configuration (component) of the master module 130 may be omitted within the scope of known technology.

The master module 130 may create the intermediate pod only when the predetermined activation condition is satisfied so that the command of the manager is able to be transmitted to the virtual machine through the worker module 110.

The predetermined activation condition may be a condition in which an integrated inconvenience index, which is an index of the inconvenience of the manager caused while using both the main interface 151 and the auxiliary interface 152, which will be described later, is greater than or equal to a predetermined reference.

A detailed explanation of a method of calculating, by the determination module 160, an integrated inconvenience index will be described later.

The virtual module 120 may provide cloud services to clients by virtualizing a plurality of virtual machines.

Unlike the full virtualization method illustrated in FIG. 1, the virtualization method on the hardware of the cloud integrated operating system may utilize a hosted virtualization method and a paravirtualization method to create a virtual machine.

Specific descriptions of virtualization and virtual machines may be omitted within the scope of known technology.

The control module 140 may manage the virtual machine of the virtual module 120 by creating, controlling, changing, or deleting the same according to a command of a manager.

The control module 140 may receive a command of a manager input to the auxiliary interface 152 and directly control the virtual module 120 according to the command of the manager.

For example, the control module 140 may be a hypervisor. However, it is not limited thereto, and specific examples of the control module 140 may be modified in various ways according to common techniques.

The interface module 150 may calculate the main interface 151 and the auxiliary interface 152 and transmit the same to the display module 170.

The main interface 151 may calculate a first main interface 151a into which a command of a manager to control the master module 130 and the worker module 110 (nodes, pods and/or containers, etc.) is able to be input, and a second main interface 151b into which the command of the manager to control the virtual machine is able to be input through the intermediate pod.

For example, the first main interface 151a and the second main interface 151b may be a user interface of a CLI type.

However, it is not limited thereto, and the types of the first main interface 151a and the second main interface 151b may be modified in various ways at a level that is obvious to those skilled in the art.

For example, the second main interface 151b may be activated and displayed by the display module 170 only when the predetermined activation condition is satisfied and the intermediate pod is activated.

The auxiliary interface 152 may be a user interface into which a command of a manager for creating, disappearing, controlling, and expanding a virtual machine is able to be input.

For example, the auxiliary interface 152 may be a user interface of a CLI type.

However, it is not limited thereto, and the type of the auxiliary interface 152 may be modified in various ways at a level that is obvious to those skilled in the art.

The main interface 151 and the auxiliary interface 152 may be configured as separate windows and displayed on the display module 170.

A shell function may be activated in the interface module 150, the control module 140, and/or the master module 130.

The determination module 160 may calculate the integrated inconvenience index and determine whether the predetermined activation condition is satisfied.

The determination module 160 may calculate the integrated inconvenience index based on log history of a manager input through the input module 180 and an input device control result of the manager displayed on the display module 170.

For example, the determination module 160 may collect information input to the input module 180 by a manager and log information generated as the interface module 150 operates from the interface module 150 and the input module 180.

In addition, the determination module 160 may collect information about the input device control result of a manager from the display module 170.

For example, the input device control result of the manager may be a mouse pointer image displayed by the display module 170. The determination module 160 may collect and analyze images displayed on the display module 170 to analyze and track the position of the mouse point image on the entire user interface displayed by the display module 170.

However, it is not limited thereto, and specific examples of the input device control result of the manager collected by the determination module 160 may be modified in various ways at a level that is obvious to those skilled in the art.

The determination module 160 may calculate the integrated inconvenience index by considering a first inconvenience index calculated by comparing a manager manipulation of the main interface 151 and a manager manipulation of the auxiliary interface 152, a second inconvenience index calculated through switching times of the main interface 151 and the auxiliary interface 152, and a third inconvenience index, which is information related to a mood of the manager, during a switching process between the main interface 151 and the auxiliary interface 152.

The determination module 160 may calculate the first inconvenience index with a difference between the time until a command of a correct manager is input into the main interface 151 after the first main interface 151a of the main interface 151 is activated (hereinafter referred to as a first time) and the time until the command of the correct manager is input into the auxiliary interface 152 after the auxiliary interface 152 is activated (hereinafter referred to as a second time).

Herein, the command of the correct manager may mean a command that may operate the master module 130, the worker module 110, the control module 140, and the virtual module 120.

For example, the first inconvenience index may be calculated only when the second time is greater than the first time.

In this connection, the larger the difference between the first time and the second time, the larger the value of the first inconvenience index may be.

For example, the determination module 160 may calculate the first inconvenience index as a numerical value between 0 and 100 or less.

A numerical value of 0 to 100 or less corresponding to the difference between the first time and the second time may be predetermined, and specific examples thereof may be modified in various ways at a level that is obvious to those skilled in the art.

The determination module 160 may calculate the second inconvenience index by averaging the time until the auxiliary interface 152 is activated after the first main interface 151a is deactivated (hereinafter referred to as a third time) and the time until the first main interface 151a is activated after the auxiliary interface 152 is deactivated (hereinafter referred to as a fourth time).

For example, as the third and fourth times increase, the value of the second inconvenience index may increase.

The larger the second inconvenience index, the longer it takes for a user to switch from the first main interface 151a to the auxiliary interface 152 or from the auxiliary interface 152 to the first main interface 151a, which may mean that the inconvenience increases.

For example, the determination module 160 may calculate the second inconvenience index as a value between 0 and 100 or less.

Depending on the average numerical value of the third time and the fourth time, a corresponding numerical value of 0 to 100 or less may be predetermined.

The determination module 160 may calculate the third inconvenience index, which is information related to a mood of a manager, by analyzing whether the input device control result of the manager has a predetermined pattern.

For example, the predetermined pattern may include a pattern in which the mouse point image repeatedly reciprocates within an arbitrary distance range.

For example, the arbitrary distance range may be 15 cm. However, it is not limited thereto, and the specific value of the arbitrary distance range may be modified in various ways at a level that is obvious to those skilled in the art.

For example, in order to be recognized as a predetermined pattern, it may have to be reciprocated three or more times. However, it is not limited thereto, and the specific numerical value of the number of times of reciprocation that needs to be moved in order to be recognized as the predetermined pattern may be modified in various ways at a level that is obvious to those skilled in the art.

For example, the predetermined pattern may further include a pattern in which the mouse point image moves at a speed higher than a predetermined speed and an angle of movement trajectory of equal to or less than a predetermined angle.

For example, the predetermined speed may be 3 m/s. However, it is not limited thereto, and the specific value of the predetermined speed may be modified in various ways at a level that is obvious to those skilled in the art.

For example, the predetermined angle may be 30 degrees. However, it is not limited thereto, and the specific value of the predetermined angle may be modified in various ways at a level that is obvious to those skilled in the art.

The determination module 160 may calculate the value of the third inconvenience index to be larger as the number of times the mouse point image reciprocates within an arbitrary distance range in a state where the first main interface 151a and/or the auxiliary interface 152 is activated for an arbitrary period of time.

In addition, the determination module 160 may calculate the value of the third inconvenience index to be larger as the more patterns there are in which the mouse point image moves at a speed higher than a predetermined speed and an angle of movement trajectory of equal to or less than a predetermined angle in a state where the first main interface 151a and/or the auxiliary interface 152 is activated for an arbitrary period of time.

Here, the arbitrary period of time may be 24 hours, but an embodiment of the present disclosure is not limited thereto.

A numerical value based on the number of times a predetermined pattern is satisfied and a numerical value based on the number of times of reciprocation within an arbitrary distance range may be predetermined in a state where the first main interface 151a and/or auxiliary interface 152 are activated for an arbitrary period of time.

For example, when the number of times of reciprocation within an arbitrary distance range is 3 or more times, the numerical value may be ‘5,’ and when the number of times thereof is 7 or more times, the numerical value may be ‘10.’

For example, when the number of times a predetermined pattern is satisfied is 5, the numerical value may be ‘50.’

For example, the determination module 160 may calculate the third inconvenience index as a numerical value between 0 and 100 or less.

The determination module 160 may calculate the integrated inconvenience index by averaging the first inconvenience index, the second inconvenience index, and the third inconvenience index.

The determination module 160 may change the weights at which the first inconvenience index, the second inconvenience index, and the third inconvenience index are reflected in the integrated inconvenience index according to the objective information of a manager.

The objective information of the manager may include the age and career information of a manager.

The objective information of the manager may be received from the manager by the determination module 160 requesting the same from the manager.

For example, as the experience of a manager as a programmer increases, the weight of the third inconvenience index is reflected increasingly higher, and the weights of the first and second inconvenience indices are reflected increasingly lower, so that the integrated inconvenience index may be calculated.

This may be because the greater the experience, the least the inconvenience of a manager is reflected in the first inconvenience index, and the second inconvenience index does not slightly reflect the inconvenience of the manager.

For example, when manager A has 5 years of experience, the weight reflected in the first and second inconvenience indices may be 0.3, respectively, and the weight reflected in the third inconvenience index may be 0.4. When manager B has 10 years of experience, the weight reflected in the first and second inconvenience indices may be 0.2, respectively, and the weight reflected in the third inconvenience index may be 0.6.

For example, as a manager is younger, the weight reflected in the first and second inconvenience indices may be reflected increasingly higher, and the weight reflected in the third inconvenience index may be reflected increasingly lower.

As a manager is younger, the less time it takes to manipulate, so the first and second inconvenience indices may be calculated to be small. In this connection, the integrated inconvenience index may also be calculated to be small, making it impossible to determine the true inconvenience of the manager.

For example, when manager A is 40 years old, the weight reflected in the first and second inconvenience indices may be 0.2, respectively, and the weight reflected in the third inconvenience index may be 0.6. When manager B is 30 years old, the weight reflected in the first and second inconvenience indices may be 0.3, respectively, and the weight reflected in the third inconvenience index may be 0.2.

Thus, the integrated inconvenience index of a manager may be calculated more accurately.

The determination module 160 may determine the weight for calculating each inconvenience index by reflecting objective information in turn. For example, after calculating the weight reflecting each inconvenience index based on ‘age,’ the weight of the inconvenience index calculated based on ‘career information’ may be adjusted to calculate the final weight.

The predetermined activation condition may be a condition in an integrated inconvenience index, which is an index of the inconvenience of the manager caused while using both the main interface 151 and the auxiliary interface 152, is greater than or equal to a predetermined reference.

For example, the predetermined reference for satisfying the predetermined activation condition may be ‘70.’

However, it is not limited thereto, and the specific value of the predetermined reference may be modified in various ways at a level that is obvious to those skilled in the art.

The interface may be activated when a manager inputs predetermined information into the interface.

The display module 170 may display the auxiliary interface 152 and the main interface 151 calculated by the interface module 150 using graphics.

For example, the display module 170 may include any device that may display images, such as a display device, screen device, or beam projector.

A display (for example, display) may include a panel, a holographic device, a projector, or control circuitry for controlling the same. The panel may, for example, be implemented as flexible, transparent, or wearable. The panel may be configured of a touch panel and one or more modules. According to one embodiment, the panel may include a pressure sensor (or force sensor) that may measure the intensity of pressure in response to the touch of a user.

The pressure sensor may be implemented integrally with the touch panel, or may be implemented as one or more sensors separate from the touch panel. The holographic device may display three-dimensional images in the air using the interference of light. The projector may display images by projecting light onto a screen. The screen may be located, for example, inside or outside an electronic device.

The input module 180 may include any device through which a manager may input commands to control the interface module 150, the control module 140, the virtual module 120, the master module 130, the worker module 110, the determination module 140, and/or the display module 170.

For example, the input module may include a mouse, keyboard, touch panel, (digital) pen sensor, key, or ultrasonic input device. The touch panel may use at least one of, for example, a capacitive type, a resistive type, an infrared type, or an ultrasonic type.

In addition, the touch panel may further include a control circuit. The touch panel may further include a tactile layer to provide a tactile response to a user. The (digital) pen sensor may be, for example, a portion of a touch panel or may include a separate recognition sheet.

In addition, the key may include, for example, physical buttons, optical keys, or keypads.

In addition, the ultrasonic input device may sense ultrasonic waves generated from an input tool through a microphone and check data corresponding to the sensed ultrasonic waves.

The management entities of the control module 140 and the virtual module 120 may be the same as or different from the management entities of the interface module 150, the determination module 160, the display module 170, the master module 130, the worker module 110, and the input module 180.

Hereinafter, the cloud integrated management method implemented by the cloud integrated management system 100 will be described.

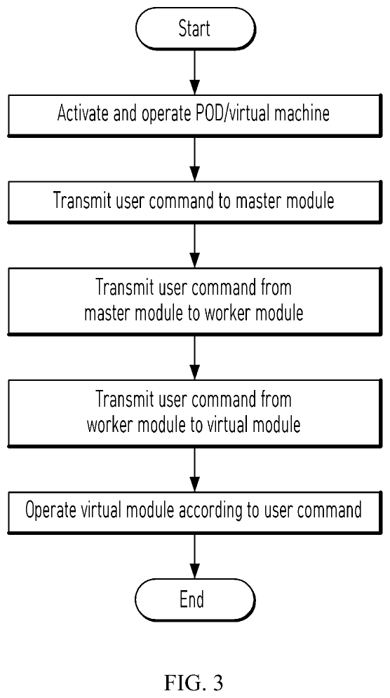

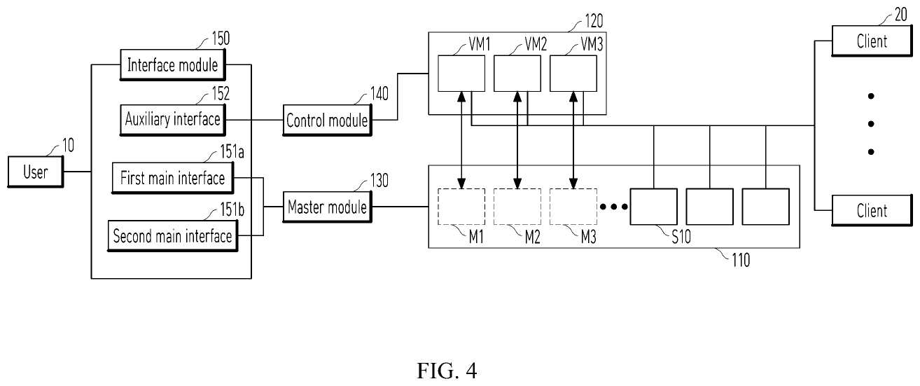

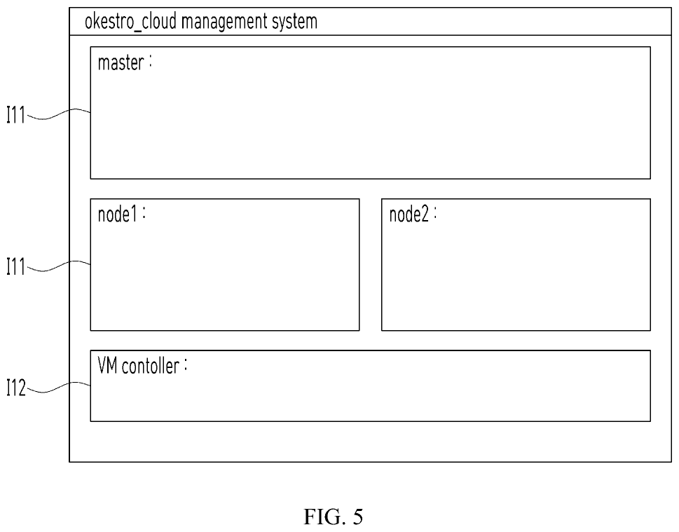

FIG. 3 is a flowchart of a cloud integrated management method according to an embodiment of the present disclosure. FIG. 4 is an operation diagram of the cloud integrated management system according to an embodiment of the present disclosure. FIG. 5 is an example of a main interface calculated by the interface module 150 of the cloud integrated management system according to an embodiment of the present disclosure.

Referring to FIGS. 2, 3, and 4, the cloud integrated management method according to an embodiment of the present disclosure may be implemented by the cloud integrated management system 100 and be configured to provide cloud services based on a container and a virtual machine, wherein the method may include: operating, by the worker module 110, at least one pod including at least one container; operating, by the virtual module 120, at least one virtual machine; receiving, by the master module 130, a command of the manager 10; and transmitting, by the master module 130, the command of the manager to the worker module 110 and the virtual machine 120.

A virtual machine may be created by the virtual module 120, and containers, pods, and nodes may be created by the worker module 110.

The client 20 may access the virtual machine and/or pod to receive necessary cloud services.

A plurality of virtual machines may be virtualized in the virtual module 120.

Herein, the entity providing the virtual machine may be different.

For example, assuming that there are a first virtual machine VM1, a second virtual machine VM2, and a third virtual machine VM3, the first virtual machine VM1 may be a virtual machine provided by Amazon, the second virtual machine VM2 may be a virtual machine provided by VMWARE, and the third virtual machine VM3 may be a virtual machine provided by Openstack.

The master module 130 may have a worker pod S10 and intermediate pods virtualized.

The intermediate pod may be composed of a plurality of intermediate pods, each connected to a virtual machine depending on the entity providing the service.

For example, assuming that there are a first intermediate pod M1, a second intermediate pod M2, and a third intermediate pod M3, the first intermediate pod M1 may be kerneled and connected to enable direct communication with the first virtual machine VM1, the second intermediate pod M2 may be kerneled and connected to enable direct communication with the second virtual machine VM2, and the third intermediate pod M3 may be kerneled and connected to enable direct communication with the third virtual machine VM3.

In order to control the worker pod, the manager may control the worker pod through the master module 130 by inputting a manager command through the first main interface 151a (see FIG. 5, I11).

In addition, when a manager inputs a command into the second main interface 151b (see FIG. 5, I12), the command of the manager may be directly delivered to the virtual machine through the master module 130 and the intermediate node.

In other words, the master module 130 may receive the command of the manager and transmit the same to the worker module 110 and the virtual machine.

When a manager inputs a command into the auxiliary interface 152, the command of the manager may be directly delivered to the virtual machine through the control module 140.

The manager may control virtual machines through each of the second main interface 151b and the auxiliary interface, but convenience of use may be increased in that nodes and virtual machines may be managed together only through the main interface 151.

The second main interface 151b and intermediate pods may be activated only when predetermined activation conditions are satisfied.

However, an embodiment of the present disclosure is not limited thereto, and an embodiment in which the second main interface 151b and intermediate pods are always activated may also be included in an embodiment of the present disclosure.

The determination module 160 may calculate an integrated inconvenience index to determine whether a predetermined activation condition is satisfied.

The integrated inconvenience index may be calculated from the first to third inconvenience indices, and detailed information may be omitted to the extent of overlap with the aforementioned content below.

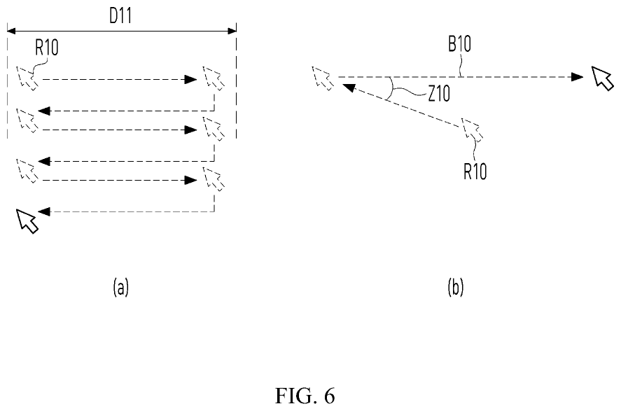

FIG. 6 is a diagram for explaining a third inconvenience index calculated by the determination module 160 of the cloud integrated management system according to an embodiment of the present disclosure.

FIG. 6(a) is a diagram for explaining one of the predetermined patterns.

The determination module 160 may determine whether a mouse point image R10 has a predetermined pattern based on whether the mouse point image R10 repeatedly reciprocates within an arbitrary distance range D11.

FIG. 6(a) may be an example illustrating a case of reciprocation three times.

FIG. 6(b) is a diagram for explaining one of the predetermined patterns.

The determination module 160 may determine whether the mouse point image R10 has a speed greater than a predetermined speed and an angle Z10 of movement trajectory B10 of the mouse point image R10 has a predetermined angle or less.

As such, by determining the inconvenience of a manager, it is possible to determine whether to activate the interface and intermediate node, thereby increasing the efficiency of cloud resources.

In the attached drawings, in order to more clearly express the technical idea of the present disclosure, configurations that are unrelated or less relevant to the technical idea of the present disclosure are briefly expressed or omitted.

Hereinabove, the configurations and features of the present disclosure have been described based on the embodiments according to the present disclosure, but the present disclosure is not limited thereto. It is obvious to those skilled in the art that various changes or modifications can be made within the spirit and scope of the present disclosure. Therefore, it is stated that such changes or modifications fall within the scope of the appended claims.

### DESCRIPTION OF REFERENCE NUMERALS

| | |
|---|---|
| 100: Worker module | 110: Virtual module |
| 120: Master module | 130: Control module |

What is claimed is:

1. A cloud integrated management system for providing integrated cloud services based on a container and a virtual machine, the system comprising:
a worker module that operates at least one pod comprising at least one container; and
a master module that receives a command of a manager and transmits the command of the manager to the worker module,
wherein the master module transmits the received command of the manager to the worker module and the virtual machine.

2. The system of claim 1, wherein the worker module comprises a worker pod that performs information processing for a cloud service provided to a client and an intermediate pod that transmits the command of the manager transmitted by the master module to the virtual machine.

3. The system of claim 2, wherein the intermediate pod is directly communicatively connected to the virtual machine through tunneling.

4. The system of claim 2, further comprising: an interface module that calculates a main interface, which is a user interface into which the command of the manager transmitted by the master module is able to be input,
wherein the interface module calculates a first main interface into which the command of the manager for controlling the worker pod is able to be input and a second main interface into which the command of the manager for controlling the virtual machine is able to be input through the intermediate pod.

5. The system of claim 2, wherein the master module creates the intermediate pod only when a predetermined activation condition is satisfied so that the command of the manager is able to be transmitted to the virtual machine through the worker module.

6. The system of claim 5, further comprising:
an interface module that calculates a main interface, which is a user interface into which the command of the manager transmitted by the master module is able to be input, and an auxiliary interface, which is different from the main interface and is a user interface into which the command of the manager for the virtual machine is able to be input; and
a determination module that determines whether the predetermined activation condition is satisfied,
wherein the predetermined activation condition is a condition in which an integrated inconvenience index, which is an index of inconvenience of the manager caused while using both the main interface and the auxiliary interface, is greater than or equal to a predetermined reference.

7. The system of claim 6, wherein the determination module calculates the integrated inconvenience index by averaging a first inconvenience index calculated by comparing a manager manipulation of the main interface and a manager manipulation of the auxiliary interface and a second inconvenience index calculated through switching times of the main interface and the auxiliary interface.

8. The system of claim 7, wherein the determination module calculates the integrated inconvenience index by further considering a third inconvenience index, which is information related to a mood of the manager, during a switching process between the main interface and the auxiliary interface.

9. The system of claim 8, wherein the determination module changes weights at which the first inconvenience index, the second inconvenience index, and the third inconvenience index are reflected in the integrated inconvenience index according to objective information of the manager.

10. A cloud integrated management method, the method being implemented by a cloud integrated management system and being configured to provide cloud services based on a container and a virtual machine, and the method comprising:
operating, by a worker module, at least one pod comprising at least one container;
receiving, by a master module, a command of a manager; and
transmitting, by the master module, the command of the manager to the worker module and the virtual machine.
